(19) United States
(12) Patent Application Publication
(10) Pub. No.: US 2023/0200426 A1
(43) Pub. Date: Jun. 29, 2023

(54) REDUCED SUGAR GLUCOSE SYRUP AND FIBER CONTAINING SYRUP

(71) Applicant: Archer Daniels Midland Company, Decatur, IL (US)

(72) Inventors: Dan Xiao, Forsyth, IL (US); Alyssa Davis, Decatur, IL (US); Michelle Schwenk, Decatur, IL (US); Leda Strand, Decatur, IL (US)

(21) Appl. No.: 17/560,942

(22) Filed: Dec. 23, 2021

(51) Int. Cl. A23L 33/26; A23L 9/10; A23L 27/60; A23L 27/30

(52) U.S. Cl. CPC A23L 33/26; A23L 9/10; A23L 27/63; A23L 27/33; A23V 2002/00

(57) ABSTRACT

A sweetener syrup comprising at least 80% wt/wt dissolved solids of an indigestible maltodextrin with the remainder of the dissolved solids comprising saccharides and oligosaccharides and wherein a ratio of trisaccharides to monosaccharides plus disaccharides is at least 1.2 to 1. Excluding the indigestible maltodextrin, trisaccharides are the dominant saccharides in the syrup typically being 30%-42% and the combination of monosaccharides and disaccharides are less than 25%. Such syrups allow the preparation of food products, illustrated by food bars, that have less than 1 g sugar per 60 g serving size. Such food bars also have prolonged shelf life. Other food products exemplified are pudding and ketchup, that can have FDA nutrition label suitable for reduced sugar claims.

### TECHNICAL FIELD

The present disclosure relates generally to a reduced sugar glucose and fiber containing syrup and food stuffs containing the same, particularly food bars, pudding and ketchup.

### BACKGROUND

A spotlight has been cast on added sugar in the food industry. Alternative options to sugars has become particularly desirable due to rising consumer concern about sugar and changes to FDA rules governing labeling of ingredients in the Nutrition Facts Panel (NFP) of a food product. Low sugar content is one of the most popular purchasing factors in the snack bar market. For snack bar application, sugar provides sweetness and functionality. Functionality, such as adhesion and water bonding, are essential to make and maintain snack bars with a desired texture and prolonged shelf life.

Some food manufacturers want to offer consumers foods that have no more than 1 g of sugar/60 g serving size and high protein (e.g., 20 g/60 g serving size). An approach to 1 g of sugar/60 g serving size that many food manufacturers took was to use isomalto-oligosaccharides (“IMO”) fiber syrup. IMO has been marketed as a low sugar prebiotic fiber sweetener. However, a recent FDA nutrition regulatory change ruled IMO out as a fiber source. All of the disaccharides of IMO, previously considered as fiber, are now labeled as added sugar.

For food labeling purposes the FDA defines sugar to be mono and disaccharides. Low sugar syrups containing more that 16% wt/wt sugars would not be suitable for making a snack bar that could be labeled 1 g of sugar/60 g serving size because the amount of sugar necessary to make such a bar using such a low sugar syrup would introduce too much sugar into the bar.

Some soluble fiber liquids contain about 1.5% wt/wt sugar would enable making a protein bar with no more than 1 g of sugar/60 g serving size in finished snack bars. While such soluble fiber liquids provide desired cohesiveness to bind inclusions, these liquids tend to lead to bars acquiring a hard and dry texture as they age, particularly longer than two (2) weeks after bar manufacture.

There is a need in the art for sweetener syrups and a fiber containing snack bar binder containing such syrups to meet consumer preference for wholesome snack choices. There is a need in the art for sweetener and fiber containing bar binder syrups that do not have the disadvantages and drawbacks of conventional syrups.

### SUMMARY

In one aspect described herein are sweetener syrups having at least 80% wt/wt of dissolved solids as soluble indigestible maltodextrin with the remainder of the dissolved solids comprising saccharides and oligosaccharides and wherein a ratio of trisaccharides to monosaccharides plus disaccharides is at least 1.2 to 1. In preferred embodiments, the indigestible maltodextrin is at least 85% wt/wt of the dissolved solids in the syrup.

In typical embodiments, excluding the indigestible maltodextrin, at least 75% of the saccharides have a degree polymerization (DP) of 10 or less and less than 25% of the saccharides are monosaccharides (DP1) or disaccharides (DP2). In preferred embodiments, less than 20% of the saccharides are monosaccharides (DP1) or disaccharides (DP2).

In other preferred embodiments, excluding the indigestible maltodextrin, trisaccharides (DP3) are the highest percentage of saccharides in the syrup. In most typical embodiments, the trisaccharides represent 32-42% of the saccharides in the syrup. In other typical embodiments, the DP3 plus DP4 saccharides represent 40%-50% of the saccharides in the syrup.

In most embodiments excluding the indigestible maltodextrin, less than 25% percent of the saccharides in the syrup have a DP of greater than 10.

In most embodiments, the sweetener syrup has a ratio of trisaccharides to monosaccharides plus disaccharides of at least 1.5 to 1. In typical embodiments the ratio of trisaccharides to monosaccharides plus disaccharides of at least 1.5:1 to 2:1.

The syrups may made by dissolving an indigestible maltodextrin into a liquid syrup having the requisite distribution of saccharides, or dissolving a dried syrup having the requisite distribution of saccharides into a liquid containing the indigestible maltodextrin. In the most convenient embodiments the sweetener syrup is made by a combination of about 50-90% wt/wt soluble indigestible maltodextrin liquid with about 10-50% wt/wt reduced glucose syrup, wherein trisaccharides are the highest percentage of saccharides in the reduced glucose syrup. As used herein, a reduced glucose syrup is syrup derived from hydrolysis of starch that contains less than 25% glucose. In certain embodiments, the indigestible maltodextrin is at least 85% wt/wt of the dissolved solids in the syrup.

Other convenient embodiments include a combination of about 80-90% wt/wt of the soluble indigestible maltodextrin liquid and about 10-20% wt/wt of the reduced glucose syrup, In exemplary embodiments, the sweetener syrup comprises a combination of about 88% wt/wt of the soluble indigestible maltodextrin liquid and about 12% wt/wt of the reduced glucose syrup.

In another aspect, a food product comprises any of the foregoing sweetener syrups, wherein the food product is characterized as having a sugar content of no more than 1 g of sugar/60 g serving size and greater than or equal to 6 g fiber/60 g serving size. In some exemplary embodiments, the food product is a food bar. Particular examples include a food bar from the group consisting of a particulate bar, a nougat bar, and a hybrid bar. In entirely different examples, the food product is a pudding or ketchup.

### DETAILED DESCRIPTION

Aspects of the invention are associated with new sweetener syrups comprising a high content of indigestible maltodextrin and a low content of mono and disaccharides. One aspect of the invention provides a sweetener syrup comprising at least 80% wt/wt dissolved solids of a soluble indigestible maltodextrin with the remainder of the dissolved solids comprising saccharides and oligosaccharides having a low degree of polymerization (DP) with at least 75% of the saccharides having a DP of 10 or less but also with less than 25% of the saccharides being monosaccharides (DP1) or disaccharides (DP2). Syrups containing less than 25% mono saccharides and disaccharides are referred to as reduced sugar glucose syrups. Preferably, the majority of oligosaccharides in the reduced sugar glucose syrup are trisaccharides (DP3). In various embodiments for use, the sweetener syrup has a ratio of trisaccharides to monosaccharides plus disaccharides of at least 1.5 to 1. In exemplary embodiments, the sweetener syrup has a ratio of trisaccharides to monosaccharides plus disaccharides in the range of 1.5:1 to 2:1.

In all embodiments, the reduced sugar glucose syrups for use in the invention have a DP1 plus DP2 content of less than 25% and more preferably less than 20%. Trisaccharides represent the highest percentage of the saccharides in the reduced sugar glucose syrups used in the invention. Preferred reduced sugar syrups have a DP3 content in the range of 32-42% of the saccharides in the syrup. The combination of DP3 plus DP4 represents 40-50% of the saccharides in the reduced glucose syrup. Less than 25% percent of the saccharides in the reduced sugar glucose syrups have a DP of greater than 10.

The foregoing reduced glucose syrups are combined with a soluble indigestible maltodextrin to form a final sweetener syrup that comprises about 50-90% (80-90% preferred) wt/wt of the soluble indigestible maltodextrin liquid and about 10-50% (10-20% preferred) wt/wt of the reduced glucose syrup. In certain embodiments, the final sweetener syrup may be formed by dissolving a solid form of the soluble indigestible maltodextrin into the reduced sugar glucose syrup. In other embodiments, the final sweetener syrup may formed by a combination of a liquid solution containing 50-90% wt/wt of soluble indigestible maltodextrin with a reduced glucose syrup solution containing solution 10-50% wt/wt saccharides and oligosaccharides.

Soluble indigestible maltodextrin are typically formed by acid hydrolysis of a starch at elevated temperatures, with or without an amylase under conditions that promote hydrolysis and rearrangement of the 1-4 and 1-6 glycosidic bonds of the starch to form nondigestible glycosidic bonds such as 1-2, 1-3, 1-5, 2-3, 2-4, 2-5, 2-6, 3-4, 3-5, 3-6, 4-5, 4-6 and/or 5-6 glycosidic bonds. In addition, the acid hydrolysis of the starch digest the starch into smaller maltodextrins with the altered bond structure. Other methods of making soluble indigestible maltodexrins are by acid hydrolysis of starch followed by enzymatic treatment with an enzyme such as triose hydrolase or glucose transferases that transfer saccharides from 1-6 or 1-4 linkages to alternative positions on the glucose molecule. Typically, the degree of polymerization, i.e., the total number of glucose residues present in the soluble indigestible maltodextrins that may be used in the present invention ranges from DP10 to about DP40, more typically DP15 to DP25. One example for making such soluble indigestible maltodextrins is described in U.S. Pat. No. 5,364,652. The soluble indigestible maltodextrin made according the foregoing patent is commercially available from Archer Daniels Midland Company (Chicago Ill.) and Matsutani Chemicals Company (Japan), available under the trade name FIBERSOL, FIBERSOL-2, FIBERSOL 2E. Liquid versions where the indigestible maltodextrin is pre-dissolved are sold under the same name with an “L” at the end, such as FIBERSOL-2 L.

In another aspect, there is provided a food product, exemplified by a food bar made by using the aforementioned sweetener syrups that comprise a combination of insoluble indigestible maltodextrin and reduced sugar glucose syrups where the food bar has a sugar content of less than 10 g, more preferably less than 5 g, and still more preferably less than 1.5 g of sugar per 60 g serving size and greater than or equal to 6 g fiber/60 g serving size.

In some embodiments the food product made using the fiber//reduced glucose syrups has a sugar content of less than 10 g of sugar/60 g serving size and greater than or equal to 6 g fiber/60 g serving size. In certain embodiments the food product has a sugar content of less than 6 g of sugar/60 g serving size and greater than or equal to 6 g fiber/60 g serving size. In some preferred embodiments, the food product has a sugar content of less than 1 g of sugar/60 g serving size and greater than or equal to 6 g fiber/60 g serving size. In a similar aspect, the food product has a sugar content of less than 10 g of sugar/40 g serving size and greater than or equal to 6 g fiber/40 g serving size. Food bars prepared using the fiber/reduced glucose syrups provided herein, especially protein containing food bars, have desirable properties of cohesiveness, softness, water activity and extended shelf life compared to protein and fiber containing food bars prepared without the reduced sugar glucose syrups used in the present invention.

Without being bound by theory, it is believed the presence of DP3 carbohydrates in the reduced glucose syrup component of the low sugar fiber syrup disclosed herein surprisingly results in desired cohesiveness while also providing desired softness and moisture retention in a hard product such as a food bar not achieved by use of soluble indigestible maltodextrin liquid alone or use of other sweetener syrups that are not low sugar glucose syrups. The reduced glucose syrups used in the present invention typically have a water activity of 0.7 to 0.8. Water activity is a defined and measurable ratio of the vapor pressure of the product under standard conditions of temperature and pressure relative to the vapor pressure of distilled water under the same conditions. The food bars made with the syrups of the present invention have a water activity of at least 0.8.

The combination of 88% wt/wt soluble indigestible maltodextrin liquid (such as Fibersol® 2 L by Archer Daniels Midland Company) and 12% of reduced glucose syrup is advantageous over conventional fiber syrups due to its simple process of manufacture, i.e., a blending of particular amounts of two existing commercial ingredients. The elegantly simple process disclosed herein provides extra fiber content and cost-effective sugar reduction solution for the food industry.

A low sugar glucose syrup having less than 25% mono saccharides and disaccharides allows for single digit sugar per serving and/or a being able to make a product that fulfills FDA requirements for labeling the product as reduced sugar and in the case of a food bar, allows labeling the bar as having less than 10 g, less than 5 g, or even less that 1 g of sugar/60 g serving size.

Exemplary low sugar high fiber food bars made herein using Fibersol® 2 L provide exceptional cohesiveness to bind inclusions. However, Fibersol® 2 L tends to make firmer bars than may be desired by food manufacturer customers and consumers. Without being bound by theory, this is believed to be due to less water bonding capacity resulting from the molecular weight distribution of carbohydrate chain length. Fibersol® has more DP 10+ than some other conventional fiber syrups, which leads to less water bonding capacity. As bars age, protein grabs free moisture away from binder syrup leading to hard and dry texture. This tendency toward becoming hard and dry is counteracted by including the reduced sugar glucose syrups used in the present invention having a high DP3 content, which increases water activity and slows the drying process providing for longer shell life.

Those skilled in the art, having the benefit of the present disclosure, will recognize that the sweetener syrup disclosed herein can be readily used in other applications, such as bakery and confectionery applications. For example, adding DP3-rich low sugar syrup to a soluble indigestible maltodextrin liquid (such as Fibersol® 2 L by Archer Daniels Midland Company) will help maintain moisture in the baked goods and improve cookie spread compare to Fibersol® alone.

The table below is a saccharide profile of several reduced sugar glucose syrup (RSGS) suitable for use in the present invention. These RSGS products are available from the Archer Daniels Midland company, internally referred to as Primo or Pancake or Reclaim or 11006, and generally sold under the brand name SWEETRIGHT™.

TABLE 1
RSGS (Primo, Pancake, Reclaim, 1116) information

| Lot | | | | | | | | | | | | |
|---|---|---|---|---|---|---|---|---|---|---|---|---|
| Sample | Sum | | | | | | | | | | | |
| Id | g/kg | UC | DP10 | DP9 | DP8 | DP7 | DP6 | DP5 | DP4 | DP3 | DP2 | DP1 |
| Primo | 785 | 132 | 6.99 | 9.88 | 11.4 | 16.3 | 41.3 | 32.8 | 70.2 | 313 | 127 | 24.1 |
| DMIX | | | | | | | | | | | | |
| 191105 | | | | | | | | | | | | |
| | | 16.81% | 0.89% | 1.26% | 1.45% | 2.08% | 5.26% | 4.18% | 8.94% | 39.9% | 16.1% | 3.07% |
| Primo | 794 | 138 | 6.93 | 9.83 | 11.2 | 16.7 | 41.9 | 32.8 | 71.8 | 316 | 125 | 23.6 |
| GATX | | | | | | | | | | | | |
| 073079 | | | | | | | | | | | | |
| | | 17.33% | 0.87% | 1.24% | 1.41% | 2.11% | 5.28% | 4.13% | 9.05% | 39.8% | 15.8% | 2.98% |
| Primo | 788 | 175 | 5.55 | 7.68 | 8.33 | 18.5 | 34.6 | 24.4 | 72.0 | 310 | 111 | 21.2 |
| SYRX | | | | | | | | | | | | |
| 200231 | | | | | | | | | | | | |
| | | 22.25% | 0.7% | 0.97% | 1.06% | 2.35% | 4.4% | 3.1% | 9.14% | 39.3% | 14.1% | 2.69% |
| Primo | 787 | 180 | 5.46 | 7.27 | 8.30 | 19.0 | 34.7 | 23.8 | 72.6 | 309 | 107 | 18.6 |
| ORD- | | | | | | | | | | | | |
| 964987 | | | | | | | | | | | | |
| | | 22.92% | 0.69% | 0.92% | 1.06% | 2.41% | 4.41% | 3.02% | 9.23% | 39.3% | 13.6% | 2.37% |
| Pancake | 792 | 111 | 6.61 | 9.12 | 11.5 | 16.2 | 34.5 | 29.5 | 62.4 | 318 | 149 | 43.5 |
| ADMX | | | | | | | | | | | | |
| 017423 | | | | | | | | | | | | |
| | | 14.07% | 0.83% | 1.15% | 1.46% | 2.04% | 4.35% | 3.73% | 7.88% | 40.14% | 18.85% | 5.49% |
| Pancake | 799 | 113 | 6.34 | 9.05 | 11.8 | 16.2 | 35.8 | 30.1 | 64.6 | 325 | 148 | 38.6 |
| ADMX | | | | | | | | | | | | |
| 017672 | | | | | | | | | | | | |
| | | 14.13% | 0.79% | 1.13% | 1.47% | 2.03% | 4.48% | 3.77% | 8.09% | 40.76% | 18.50% | 4.84% |
| Pancake | 793 | 119 | 6.59 | 9.38 | 11.5 | 16.1 | 37.4 | 31.0 | 65.7 | 321 | 142 | 33.0 |
| ADMX | | | | | | | | | | | | |
| 019237 | | | | | | | | | | | | |
| | | 15.02% | 0.83% | 1.18% | 1.46% | 2.03% | 4.72% | 3.90% | 8.29% | 40.54% | 17.86% | 4.16% |
| Pancake | 804 | 158 | 5.93 | 8.42 | 9.94 | 16.8 | 36.7 | 28.2 | 67.7 | 295 | 128 | 50.3 |
| DMIX | | | | | | | | | | | | |
| 190398 | | | | | | | | | | | | |
| | | 19.56% | 0.74% | 1.05% | 1.24% | 2.09% | 4.56% | 3.50% | 8.42% | 36.67% | 15.90% | 6.25% |
| Pancake | 676 | 134 | 4.72 | 6.51 | 7.66 | 14.5 | 29.2 | 22.2 | 56.0 | 243 | 108 | 49.5 |
| DMIX | | | | | | | | | | | | |
| 190020 | | | | | | | | | | | | |
| | | 19.85% | 0.70% | 0.96% | 1.13% | 2.15% | 4.32% | 3.28% | 8.29% | 35.96% | 16.02% | 7.32% |
| Pancake | 792 | 171 | 5.81 | 8.18 | 9.14 | 18.9 | 33.9 | 25.5 | 66.8 | 281 | 119 | 53.1 |
| ADMX | | | | | | | | | | | | |
| 017149 | | | | | | | | | | | | |
| | | 21.59% | 0.73% | 1.03% | 1.15% | 2.38% | 4.28% | 3.22% | 8.43% | 35.45% | 15.01% | 6.71% |
| Pancake | 791 | 165 | 4.99 | 7.26 | 8.32 | 17.7 | 31.7 | 23.8 | 63.3 | 271 | 129 | 69.3 |
| ORD- | | | | | | | | | | | | |
| 965043 | | | | | | | | | | | | |
| | | 20.91% | 0.63% | 0.92% | 1.05% | 2.24% | 4.00% | 3.01% | 8.00% | 34.23% | 16.25% | 8.76% |
| Reclaim | 795 | 124 | 5.88 | 9.04 | 11.5 | 15.4 | 32.1 | 28.9 | 57.0 | 290 | 156 | 66.9 |
| ADMX | | | | | | | | | | | | |
| 019112 | | | | | | | | | | | | |
| | | 15.54% | 0.74% | 1.14% | 1.45% | 1.94% | 4.03% | 3.63% | 7.16% | 36.42% | 19.55% | 8.41% |
| Reclaim | 807 | 175 | 5.95 | 7.97 | 9.15 | 19.1 | 31.7 | 24.4 | 62.3 | 263 | 128 | 80.5 |
| DMIX | | | | | | | | | | | | |
| 190671 | | | | | | | | | | | | |
| | | 21.66% | 0.74% | 0.99% | 1.13% | 2.36% | 3.93% | 3.03% | 7.73% | 32.58% | 15.87% | 9.98% |
| 11006 | 815 | 136 | 6.88 | 10.0 | 12.0 | 16.7 | 40.5 | 32.0 | 70.8 | 327 | 136 | 27.3 |
| | | 16.68% | 0.84% | 1.23% | 1.47% | 2.05% | 4.96% | 3.93% | 8.68% | 40.16% | 16.63% | 3.35% |

*Results reported in g/kg;
DPI is dextrose;
UC is unretained compounds

The following Examples provide further disclosure of aspects of the invention.

### Example 1

Mix Fibersol® 2 L (88% wt/wt) and the reduced sugar syrup shown in Table 1 above (12% wt/wt) in a Hobart mixer for about 30 minutes to form the “Fiber syrup.” The resultant fiber syrup product would have nutritional information label, saccharide distribution (Table 2), characteristics (Table 3), and compare to other syrups (Table 4) as follows:

Nutrition Facts

| Serving size | (100 g) |
|---|---|
| Amount Per Serving | |
| Calories | 140 |

% Daily Value*

| | |
|---|---|
| Total Fat 0 g | 0% |
| Saturated Fat 0 g | 0% |
| Trans Fat 0 g | |
| Cholesterol 0 mg | 0% |
| Sodium 0 mg | 0% |
| Total Carbohydrate 71 g | 26% |
| Dietary Fiber 58 g | 206% |
| Total Sugars 3 g | |
| Includes 3 g Added Sugars | 6% |
| Protein 0 g | |
| Vitamin D 0 mcg | 0% |
| Calcium 0 mng | 0% |
| Iron 0 mg | 0% |
| Potassium 0 mng | 0% |

*The % Daily Value (DV) tells you how much a nutrient in a serving of food contributes to a daily diet. 2,000 calories a day is used for general nutrition advice.

TABLE 2
Saccharide Distribution:

| Sample | | | | | | | | | | | | |
|---|---|---|---|---|---|---|---|---|---|---|---|---|
| Id | UC | DP11 | DP10 | DP9 | DP8 | DP7 | DP6 | DP5 | DP4 | DP3 | DP2 | DP1 |
| Fiber | 333.3 | 20.3 | 24.3 | 28.2 | 31.7 | 37.6 | 47.2 | 46.2 | 22.6 | 46.3 | 19.9 | 8.9 |
| Syrup | | | | | | | | | | | | |
| | 50.00% | 3.05% | 3.64% | 4.24% | 4.76% | 5.65% | 7.08% | 6.93% | 3.39% | 6.95% | 2.98% | 1.33% |

*Results reported in g/kg;
DPI is dextrose;
UC is unretained compounds

TABLE 3
Characteristics of Fiber Syrup

| | | | | | | | MW |
|---|---|---|---|---|---|---|---|
| | RI | | | | Fiber | | (number |
| Sample | Value | % DS | pH | Aw | as is | Viscosity | avg) |
| Fiber | 1.47439 | 71.80% | 3.42 | 0.8817 | 611.10 | 2104- | 1457 |
| Syrup | | | | | g/kg | 2429 cP | |

RI is reflective index, a measure of concentration of carbohydrate solutions.
DS is dissolved solids.
Aw is water activity ratio of pure water availability.

TABLE 4
Comparison of Fiber Syrup to other syrups

| | | | | | | Viscosity | |
|---|---|---|---|---|---|---|---|
| | | | | | | (Brookfield | MW |
| | | | | | | RV at | (number |
| Sample | RI Value | % DS | pH | Aw | Fiber | 120F) | avg) |
| Fiber Syrup | 1.47439 | 71.80% | 3.42 | 0.8817; | 611.10 | 2104-2429 | 1457 |
| | | | | 0.8798 | g/kg | cP | |
| Fibersol ® 2L | 1.47155 | 68.5-71.5 | 3.39 | 0.8944; | 900.23 | 1544 cP | 1416 |
| | | | | 0.8835 | g/kg | | |
| Reduced | 1.49441 | 79.73% | 4.39 | 0.7817 | 0 | 8625 cP | — |
| sugar glucose | | | | | | | |
| syrup | | | | | | | |
| (RSGS), also | | | | | | | |
| referred to as | | | | | | | |
| Primoor | | | | | | | |
| Pancake or | | | | | | | |
| Reclaim or | | | | | | | |
| 1116 | | | | | | | |
| IMO syrup | ___ | 75-77% | 4.26 | <0.8 | 0 | — | |
| 42 DE | 1.49446 | 81.6 | 4.54 | 0.7368 | 0 | 9751 cP | — |
| Com syrup | | | | | | | |

Fibersol 2L water activity measured at 24.06° C. with a time to reach dew point: of 4.01 minutes.
Fibersol/Primo syrup water activity was measured at 24.28° C. with a time to reach dew point: 3.06 minutes The fiber syrup was mixture of Fibersol and Primo syrups 88% and 12% respectively.

The ranges for DP1, DP3, and DP4 values along with indigestible maltodextrin fiber content of various fiber syrups are as follows: DP1 and DP2: 1-5%, DP3: 5-15%, DP4+: 80-94%, Fiber Content dry solids base (dsb): 80-85%.

### Example 2

Comparison of Fibersol® 2 L to the combination fiber syrup in a high protein nougat bar (apple cinnamon bar). Nougat bar herein means a bar with protein powder that has a dough-like texture and does not have particulates sufficiently large enough to be visible to the human eye. The Fiber syrup is a blend of 88% wt/wt Fibersol and 12% wt/wt Primo. The combination Fiber syrup-made nougat bars were softer than bars made with Fibersol® 2 L alone. Example 2 data is shown in Table 5.

TABLE 5
Nougat Bar 60 g serving size

| | Nougat Bar 60 g serving | | | |
|---|---|---|---|---|
| | | Apple | | |
| | | Cinnamon | | Apple Cinnamon |
| | | Fibersol/Primo | Apple | Fibersol/Primo |
| | Apple Cinnamon | moisture | Cinnamon | 88/12 (non- |
| | Fibersol | adjusted (MA) | IMO | moisture adjusted) |
| Fiber g | 10.294 | 8.918 | 12.15 | 8.976 |
| Sugar g | 1.211 | 1.469 | 1.495 | 1.47 |
| Carbohydrates g | 27.055 | 27.008 | 28.43 | 27.207 |
| Protein g | 20.294 | 20.295 | 20 | 20 |
| Calories kcal | 190 | 190 | 200 | 190 |
| Moisture | 12.41% | 12.48% | 10.05 | 12.15% |
| aw | 0.63 | 0.62 | 0.6 | 0.62 |
| 1-month tasting | firm and dry | softer than | soft and | softer than Fibersol |
| notes | texture | Fibersol alone, | moist | alone, firmer than |
| | | firmer than | texture | MA |
| | | IMO | | |
| 10-month tasting | firm and dry | softer than | soft and | softer than Fibersol |
| notes | texture | Fibersol alone, | moist | alone, firmer than |
| | | firmer than | texture | MA |
| | | IMO | | |

### Example 3

Comparison of Fibersol® 2 L to the Fiber syrup in a hybrid bar (banana muffin) having a 40 g serving size. Hybrid bar as used herein means a bar comprising both protein powder and particulates, wherein the particulates are sufficiently large to be visible to the human eye. The hybrid bar of this experiment has less of dough-like texture than the nougat bar in Example 2. The combination fiber syrup-made hybrid bars were softer than bars made with Fibersol® 2 L. Example 3 data is shown in Table 6.

TABLE 6
Hybrid Bar (banana muffin bar), 40 g serving size

| | Hybrid Bar 40 g serving | |
|---|---|---|
| | Banana Muffin | Banana Muffin |
| | Fibersol | Fibersol/Primo MA |
| Fiber g | 6.236 | 5.688 |
| Sugar g | 5.576 | 5.688 |
| Carbohydrates g | 19.283 | 19.262 |
| Protein g | 8.638 | 8.639 |
| Calories kcal | 160 | 160 |
| Moisture | 11.60% | 11.65% |
| aw | 0.5452 | 0.5348 |
| 1-month tasting notes | drier and firmer | softer and looser texture |
| 10-month tasting notes | drier and firmer | softer texture |

### Example 4

Comparison of Fibersol® 2 L to the Fiber syrup in a particulate bar. Particulate bar as used herein means a bar comprising particulates, wherein the particulates are sufficiently large to be visible to the human eye. The combination Fiber syrup-made particulate bars were softer than bars made with Fibersol® 2 L. (ELN record 2018-1120-020). Example 4 results are shown in Table 7.

TABLE 7
Particulate Bar (lemon bar), 40 g serving size

| | Particulate Bar 40 g serving | |
|---|---|---|
| | Lemon Bar | Lemon Bar |
| | Fibersol | Fibersol/Primo |
| Fiber g | 8.684 | 7.93 |
| Sugar g | 0.657 | 0.798 |
| Carbohydrates g | 14.668 | 14.75 |
| Protein g | 13.792 | 13.792 |
| Calories kcal | 150 | 160 |
| Moisture | 8.52% | 8.30% |
| aw | 0.5662 | 0.55 |
| 1-month tasting | dry texture, | dry texture, |
| notes | firmer | softer |
| 10-month tasting | firmer | softer |
| notes | | |

### Example 5

Use of the Fiber syrup in a vanilla pudding. Add Fibersol/Primo blend, sugar, starch, salt, and milk into a Thermomix bowl. Cook 12 min/195 degrees F./speed 3. Add butter and vanilla. Mix 10 sec/speed 4. Transfer immediately to dessert bowls and allow to cool. Refrigerate to set. The pudding was made according to the following table.

TABLE 8
Vanilla pudding with Fiber syrup (Fibersol 2 L/Primo Blend 88/12)

| Component | Amount (grams) | Weight % |
|---|---|---|
| Fiber syrup | 26.10 | 5.2202 |
| Granulated white sugar | 15.00 | 3.0001 |
| Modified food starch | 19.9377 | 3.9877 |
| Salt | 0.4922 | 0.0984 |
| Milk, 2% | 418.0700 | 83.6174 |
| Unsalted butter | 17.6822 | 3.5366 |
| Wild Natural vanilla | 2.6978 | 0.5396 |
| flavor WONF | | |
| Total | 499.9800 | 100% |

The resultant vanilla pudding product has nutritional information as follows:

Nutrition Facts

| serving per container | |
|---|---|
| Serving size | 1 cup (156 g) |
| Amount Per Serving | |
| Calories | 160 |

% Daily Value*

| | |
|---|---|
| Total Fat 7 g | 9% |
| Saturated Fat 4.5 g | 22% |
| Cholesterol 20 mg | 7% |
| Sodium 125 mg | 6% |
| Total Carbohydrates 23 g | 8% |
| Dietary Fiber 5 g | 17% |
| Total Sugars 11 g | |
| includes 5g Added Sugars | 10% |
| Protein 4g | |
| Calcium 160 mg | 10% |
| Potassium 180 mg | 4% |
| Vitamin A | 18% |
| Thiamin | 4% |
| Riboflavin | 28% |
| Vitamin B6 | 2% |
| Vitamin B12 | 38% |
| Pantothenic Add | 18% |
| Phosphorus | 18% |
| Magnesium | 4% |
| Zinc | 6% |
| Selenium | 8% |

Not a Significant Source of trans fatty acids, vitamin D and iron.
*The % Daily Value (DV) tells you how much a nutrient in a serving of food contributes to a daily diet. 2,000 calories a day is used for general nutrition advice.

In comparison, a “control” vanilla pudding made in the same manner as above, but without the Fiber syrup, results in a vanilla pudding that per serving size of 1 cup (156 grams), has more calories (180 vs. 160 calories), more grams of total sugars (19 vs. 11 grams), more grams of added sugars (13 vs. 5 grams), and less grams of fiber (0 vs. 5 grams) than the above vanilla pudding made with the Fiber syrup. The control vanilla pudding has the following components, and a nutritional panel as shown below.

TABLE 8
Vanilla pudding without Fiber syrup

| Component | Amount (grams) | Weight % |
|---|---|---|
| Granulated white sugar | 41.1215 | 8.2243 |
| Modified food starch | 19.9377 | 3.9877 |
| Salt | 0.4922 | 0.0984 |
| Milk, 2% | 418.0685 | 83.6137 |
| Unsalted butter | 17.6822 | 3.5364 |
| Wild Natural vanilla | 2.6978 | 0.5396 |
| flavor WONF | | |
| Total | 500.0000 | 100% |

The resultant control vanilla pudding product has nutritional information as follows:

Nutrition Facts

| serving per container | |
|---|---|
| Servingsize | 1 cup (156 g) |
| Amount Per Serving | |
| Calories | 180 |

% Daily Value*

| Total Fat 7 g | 9% |
|---|---|
| Saturated Fat 4.5 g | 22% |
| Cholesterol 20 g | 7% |
| Sodium 125 mg | 6% |
| Total Carbohydrates 25 g | 9% |
| Total Sugars 19 g | |
| Includes 13 g Added Sugars | 26% |
| Protein 4 g | |
| Calcium 160 mg | 10% |
| Potassium 180 mg | 4% |
| Vitamin A | 10% |
| Thiamin | 4% |
| Riboflavin | 20% |
| Vitamin B6 | 2% |
| Vitamin B12 | 30% |
| Pantothenic Acid | 10% |
| Phosphorus | 10% |
| Magnesium | 4% |
| Zinc | 6% |
| Selenium | 8% |

Not a Significant Source of: trans fatty acids, dietary fiber, vitamin D and iron.
*The % Daily Value (DV) tells you how much a nutrient in a serving of food contributes to a daily diet. 2,000 calories a day is used for general nutrition advice.

The vanilla pudding made with the Fiber syrup disclosed herein had a stronger dairy flavor than the “control” vanilla pudding and had more subtle sweetness and vanilla flavor than the control vanilla pudding.

### Example 6

Use of the Fiber syrup in a ketchup. Add Fibersol/Primo blend, filtered water, salt, vinegar, and tomato paste in a Thermomix bowl. Cook for 15 minutes at 220 degrees F. on low speed, and then allow to cool. The ketchup had the amounts of components according to the following table.

TABLE 9
Ketchup with Fiber syrup (Fibersol 2 L/Primo Blend 88/12)

| Component | Amount (grams) | Weight % |
|---|---|---|
| Filtered water | 204.1950 | 40.8390 |
| Salt | 5.2450 | 1.0490 |
| Apple cider vinegar | 49.6500 | 9.9300 |
| Tomato paste | 152.0950 | 30.4190 |
| Fiber syrup | 88.8150 | 17.7630 |
| Total | 500.0000 | 100% |

The resultant ketchup has nutritional information as follows:

Nutrition Facts

| serving per container | |
|---|---|
| Serving size | 1 Tbsp (17 g) |
| Amount Per Serving | |
| Calories | 10 |

% Daily Value*

| | |
|---|---|
| Total Fat 0 g | 0% |
| Sodium 70 mg | 3% |
| Total Carbohydrates 3 g | 1% |
| Dietary Fiber 2 g | 7% |
| Protein 0 g | |

Not a Significant Source of: Saturated fat, trans fatty acids, cholesterol, total sugars, added sugars, vitamin D, calcium, iron and potassium
*The % Daily Value (DV) tells you how much a nutrient in a serving of food contributes to a daily diet. 2,000 calories a day is used for general nutrition advice.

In comparison, a control ketchup made in the same manner as above, but with 62/43 corn syrup and high fructose corn syrup, Cornsweet 42 and without the Fiber syrup, results in a ketchup that per serving size of 1 tablespoon (17 grams), has more calories (15 vs. 10 calories), more grams of total sugars (2 vs. 0 grams), more grams of added sugars (2 vs. 0 grams), less grams of fiber (0 vs. 2 grams) than the above ketchup made with the Fiber syrup. The control ketchup had the following amounts of components, and a nutritional panel as shown below.

TABLE 10
Ketchup made 62/43 corn syrup and high fructose corn syrup,
Cornsweet 42, and without the Fiber syrup

| Component | Amount (grams) | Weight % |
|---|---|---|
| Filtered water | 204.1950 | 40.8390 |
| Salt | 5.2450 | 1.0490 |
| Apple cider vinegar | 49.6500 | 9.9300 |
| Tomato paste | 152.0950 | 30.4190 |
| 62/43 Corn syrup- | 59.095 | 11.8190 |
| 011056 | | |
| High fructose corn syrup, | 29.720 | 5.9440 |
| Cornsweet 42 | | |
| Total | 500.0000 | 100% |

The resultant control ketchup has nutritional information as follows:

Nutrition Facts

| serving per container | |
|---|---|
| Serving size | 1 Tbsp (17 g) |
| Amount Per Serving | |
| Calories | 15 |

% Daily Value*

| | |
|---|---|
| Total Fat 0 g | 0% |
| Sodium 70 mg | 3% |
| Total Carbohydrates 3 g | 1% |
| Total Sugars 2 g | |
| Includes 2g Added Sugars | 4% |
| Protein 0 g | |

Not a Significant Source of: saturated dat, trans fatty acids, cholesterol, dietary fiber, vitamin D, calcium, iron and potassium.
*The % Daily Value (DV) tells you how much a nutrient in a serving of food contributes to a daily diet. 2,000 calories a day is used for general nutrition advice.

The tomato ketchup made with the Fiber syrup disclosed herein had a strong acidic flavor, wherein the tomato and sweet notes were somewhat masked by the acidity, as compared to the “control” ketchup.

Those skilled in the art having the benefit of the present disclosure will recognize that advantages of the present invention include a unique carbohydrate molecular distribution of low mono and di saccharides, high DP3 and high fiber content. Conventional low sugar syrups do not have similar molecular distribution or fiber content to the Fiber syrup disclosed herein. The high DP3, low mono and di saccharide and high fiber content contributes to finished good soft and moist texture and stability.

The high DP3 content of the Fiber syrup disclosed herein allows for replacement of sugars and IMO while keeping the calories low. The Fiber syrup disclosed herein gives desired humectancy, cohesiveness and chewiness in bars and other food products. The Fiber syrup of the present invention maintains a moist mouth feel over storage versus conventional fiber syrups and glucose syrups. The Fiber syrup of the present invention gives a unique low viscosity that provides ease of handling and incorporation. The Fiber syrup disclosed herein allows for food products to meet low sugar levels, e.g., no more than 1 g of sugar/serving size (e.g., either 60 g serving size or 40 g serving size). The Fiber syrup of the present disclosure is a sweetener syrup that provides desired cohesiveness and desired soft and moist texture in snack bars. The Fiber syrup of the present invention is an excellent replacement of IMO because it allows food products to have a low level of sugar (1 g of sugar/serving) and a medium fiber content of 6 g or more per 60 g serving size.

Those skilled in the art having the benefit of the present disclosure will recognize that advantages of the present invention include a unique carbohydrate molecular distribution of low mono and di saccharides, high DP3 and high fiber content. Conventional low sugar syrups do not have similar molecular distribution or fiber content to the Fiber syrup disclosed herein. The high DP3, low mono and di saccharide and high fiber content contributes to finished good soft and moist texture and stability.

The high DP3 content of the Fiber syrup disclosed herein allows for replacement of sugars and IMO while keeping the calories low. The Fiber syrup disclosed herein gives desired humectancy, cohesiveness and chewiness in bars and other food products. The Fiber syrup of the present invention maintains a moist mouth feel over storage versus conventional fiber syrups and glucose syrups. The Fiber syrup of the present invention gives a unique low viscosity that provides ease of handling and incorporation. The Fiber syrup disclosed herein allows for food products to meet low sugar levels, e.g., no more than 1 g of sugar/serving size (e.g., either 60 g serving size or 40 g serving size). The Fiber syrup of the present disclosure is a sweetener syrup that provides desired cohesiveness and desired soft and moist texture in snack bars. The Fiber syrup of the present invention is an excellent replacement of IMO because it allows food products to have a low level of sugar (1 g of sugar/serving) and a medium fiber content of 6 g or more per 60 g serving size.

Those skilled in the art having the benefit of the present disclosure will recognize that manufacturing techniques (using enzymes and acids) to produce the low sugar component of the Fiber syrup allows for the manufacture of a Fiber syrup to having a desired saccharide distribution of fiber and low sugar and higher relative DP3 than conventional syrups.

Those having skill in the art, with the knowledge gained from the present disclosure, will recognize that various changes can be made to the disclosed compositions and processes in attaining the advantages disclosed herein and other advantages, without departing from the scope of the present disclosure. As such, it should be understood that the features of the disclosure are susceptible to modifications and/or substitutions. The specific embodiments illustrated and described herein are for illustrative purposes only, and not limiting of the invention as set forth in the appended claims.

What is claimed is:

1. A sweetener syrup comprising at least 80% wt/wt dissolved solids as soluble indigestible maltodextrin with the remainder of the dissolved solids comprising saccharides and oligosaccharides and wherein a ratio of trisaccharides to monosaccharides plus disaccharides is at least 1.2 to 1.

2. The sweetener syrup of claim 1, wherein the indigestible maltodextrin is at least 85% wt/wt of the dissolved solids in the syrup.

3. The sweetener syrup of claim 1 wherein excluding the indigestible maltodextrin, at least 75% of the saccharides have a degree polymerization (DP) of 10 or less and less than 25% of the saccharides are monosaccharides (DP1) or disaccharides (DP2).

4. The sweetener syrup of claim 3 wherein less than 20% of the saccharides are monosaccharides (DP1) or disaccharides (DP2).

5. The sweetener syrup of claim 3 wherein excluding the indigestible maltodextrin, trisaccharides (DP3) are the highest percentage of saccharides in the syrup.

6. The sweetener syrup of claim 5 the trisaccharides represent 32-42% of the saccharides in the syrup.

7. The sweetener syrup of claim 5 wherein DP3 plus DP4 saccharides represent 40%-50% of the saccharides in the syrup.

8. The sweetener syrup of claim 1 wherein excluding the indigestible maltodextrin, less than 25% percent of the saccharides in the syrup have a DP of greater than 10.

9. The sweetener syrup of claim 1 wherein the sweetener syrup has a ratio of trisaccharides to monosaccharides plus disaccharides of at least 1.5 to 1.

10. The sweetener syrup of claim 4 wherein the sweetener syrup has a ratio of trisaccharides to monosaccharides plus disaccharides of at least 1.5:1 to 2:1.

11. The sweetener syrup of claim 10, wherein the indigestible maltodextrin is at least 85% wt/wt of the dissolved solids in the syrup.

12. The sweetener syrup of claim 1 comprising a combination of about 50-90% wt/wt soluble indigestible maltodextrin liquid and about 10-50% wt/wt reduced glucose syrup, wherein trisaccharides are the highest percentage of saccharides in the reduced glucose syrup.

13. The sweetener syrup of claim 12 comprising a combination of about 80-90% wt/wt of the soluble indigestible maltodextrin liquid and about 10-20% wt/wt of the reduced glucose syrup,

14. The sweetener syrup of claim 1, comprising a combination of about 88% wt/wt of the soluble indigestible maltodextrin liquid and about 12% wt/wt of the reduced glucose syrup.

15. A food product comprising the sweetener syrup of claim 1, wherein the food product is characterized as having a sugar content of no more than 1 g of sugar/60 g serving size and greater than or equal to 6 g fiber/60 g serving size.

16. The food product of claim 15, wherein the food product is a food bar.

17. The food product of claim 16, wherein the food bar is selected from the group consisting of a particulate bar, a nougat bar, and a hybrid bar.

18. The food product of claim 15 wherein the food product is a pudding.

19. The food product of claim 15 wherein the food product is a ketchup.
